(19) United States
(12) Patent Application Publication
(10) Pub. No.: US 2025/0203402 A1
(43) Pub. Date: Jun. 19, 2025

(54) METHOD TO ENABLE PROVISION OF USER EQUIPMENT APPARATUS ANALYTICS IN A ROAMING NETWORK

(71) Applicant: Lenovo (Singapore) Pte. Limited, Singapore (SG)

(72) Inventors: Andreas Kunz, Ladenburg (DE); Sheeba Backia Mary Baskaran, Friedrichsdorf (DE); Dimitrios Karampatsis, Ruislp (GB); Emmanouil Pateromichelakis, Viersen (DE)

(73) Assignee: Lenovo (Singapore) Pte. Limited, Singapore (SG)

(21) Appl. No.: 18/852,789

(22) PCT Filed: May 13, 2022
(86) PCT No.: PCT/EP2022/063100

§ 371 Date: Sep. 30, 2024

(30) Foreign Application Priority Data
Mar. 31, 2022 (GR) 20220100288

(51) Int. Cl. H04W 24/02; H04W 12/06; H04W 12/106; H04W 84/04

(52) U.S. Cl. CPC H04W 24/02; H04W 12/06; H04W 12/106; H04W 84/042

(57) ABSTRACT

An apparatus comprising: a transceiver; and a processor coupled to the transceiver, the processor and the transceiver configured to cause the apparatus to: receive a monitoring configuration request from a trust surveillance network function, the monitoring configuration request comprising: an identifier for a Visited Public Land Mobile Network, VPLMN; information specifying a parameter set to be monitored; and an address of an application function, AF; select a user equipment, UE, apparatus registered in a VPLMN identified by the identifier; and send, to the selected UE apparatus, a monitoring configuration message, the monitoring configuration message comprising: the information specifying the parameter set to be monitored; and the address of the AF.

### FIELD OF THE INVENTION

The present invention relates to procedures to instruct a user equipment apparatus to perform certain measurements and analytics in a visited network and to collect reports to be sent securely to a home network of the user equipment apparatus.

### BACKGROUND

Currently, certain special user equipment apparatus (UEs) can perform certain radio measurements for the feature “Minimizing Drive Tests” (MDT), wherein the UEs are instructed in a “RRC CONNECTED” mode by an evolved Node B (eNB) or Next Generation Node B (gNB) to perform extra measurements when being in a “RRC IDLE” mode. These measurements are related to specific radio conditions each of the UEs experiences.

Another related feature is the configuration of the UE to perform Quality of Experience (QoE) measurements and to transmit them to the gNB or a QoE server in the serving network. These QoE reports may be configured for specific applications.

Further, the feature of enablers for Network Automation defines a Network Data Analytics Function (NWDAF) in a home Public Land Mobile Network (HPLMN) that can provide analytics based on input of particular Network Functions (NFs) within the HPLMN. Thus far, the NWDAF cannot receive or request analytics from a UE on behalf of a NF consumer, but rather can only create analytics about potentially misbehaving UEs based on input from NFs in the HPLMN.

### SUMMARY OF THE INVENTION

In an aspect there is provided an apparatus comprising a transceiver and a processor coupled to the transceiver. The processor and the transceiver are configured to cause the apparatus to receive a monitoring configuration request from a trust surveillance network function. The monitoring configuration request comprises an identifier for a Visited Public Land Mobile Network, VPLMN; information specifying a parameter set to be monitored; and an address of an application function, AF. The processor and the transceiver are further configured to: cause the apparatus to select a user equipment, UE, apparatus registered in a VPLMN identified by the identifier; and send, to the selected UE apparatus, a monitoring configuration message. The monitoring configuration message comprises the information specifying the parameter set to be monitored, and the address of the AF.

In a further aspect there is provided a user equipment, UE, apparatus comprising a transceiver and a processor coupled to the transceiver. The processor and the transceiver are configured to cause the UE apparatus to receive a monitoring configuration message. The monitoring configuration message comprises information specifying the parameter set to be monitored, and an address of an application function, AF. The processor and the transceiver are further configured to cause the UE apparatus to: perform monitoring of the specified parameter set of a Visited Public Land Mobile network, VPLMN, with which the UE apparatus is registered; and send a monitoring results report comprising a result of said monitoring to the address of the AF.

In a further aspect there is provided an apparatus comprising a transceiver, and a processor coupled to the transceiver. The processor and the transceiver configured to cause the apparatus to receive a protection request message comprising a monitoring configuration message and an identifier for a user equipment, UE, apparatus. The monitoring configuration message comprises information specifying a parameter set to be monitored, and the address of an application function, AF. The processor and the transceiver are further configured to cause the apparatus to: select a protection key for the monitoring configuration message using the identifier for the UE apparatus; compute a keystream block with the protection key and an encryption algorithm; compute a ciphertext block using the monitoring configuration message and the keystream block, thereby to provide a protected monitoring configuration message; and send, in response to the protection request message, a response message comprising the protected monitoring configuration message and an encryption algorithm identifier that identifies the encryption algorithm.

In a further aspect there is provided an apparatus comprising a transceiver, and a processor coupled to the transceiver. The processor and the transceiver are configured to cause the apparatus to receive a monitoring configuration request from a trust surveillance network function. The monitoring configuration request comprises: an identifier for a Visited Public Land Mobile Network, VPLMN; information specifying a parameter set to be monitored; and an address of an application function, AF. The processor and the transceiver are further configured to cause the apparatus to: receive a key request from an Application Function, AF; acquire a Serving Network Name of a user equipment, UE, apparatus; detect whether the Serving Network Name of the UE apparatus is alike (e.g. the same as) the VPLMN identified by the identifier; and, responsive to detecting that the Serving Network Name of the UE apparatus is alike with the VPLMN identified by the identifier, in response to the key request, send a key response message to the AF, the key response message comprising the monitoring configuration request.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

FIG. 1 is a schematic illustration (not to scale) of a roaming architecture.

FIG. 2 is a schematic illustration (not to scale) of a user equipment apparatus that may be used for implementing the methods described herein.

FIG. 3 is a schematic illustration (not to scale) of a network node that may be used for implementing the methods described herein.

FIG. 4 is a schematic illustration (not to scale) of a procedure for configuring the user equipment apparatus via a Unified Data Management system in a Home Public Land Mobile Network.

FIG. 5 is a schematic illustration (not to scale) of a procedure for protecting a Monitoring Configuration payload with a block cipher.

FIG. 6 is a schematic illustration (not to scale) of a procedure for provisioning the Monitoring Configuration to the user equipment apparatus via an Application Function, returning a Monitoring Results Report to a Network Data Analytics Function for analysis, and relaying the resulting analytics to a Trust Surveillance Network Function.

FIG. 7 is a schematic illustration (not to scale) of a procedure for Application Session Establishment via Application Function provisioning.

### DETAILED DESCRIPTION

A Trust Surveillance function is responsible for verifying the current trust status in a network, and for detecting when a NF is exceeding a certain threshold based on behaviour categorized as undesired or malicious. This Trust Surveillance can be further extended to a visited network. Thus far, there are no procedures to instruct the UE to perform certain measurements and analytics in a visited network, to collect those reports, and to send them securely to a home network, e.g. a HPLMN. It is desired that the visited network, which is subject to monitoring for potential service level agreement violations, does not detect that the UE is configured for such measurements.

A Trust Surveillance NF in the HPLMN provides a Monitoring Configuration for a specific visitor Public Land Mobile Network (VPLMN) either to a Unified Data Management (UDM), Authentication and key management for applications (AKMA) Anchor function (AAnF) or Application Function (AF). The UE is provisioned with this Monitoring Configuration either via Steering of Roaming (SoR)/UE Parameter Update (UPU) procedure or via a secure user plane on the application layer. The UE performs monitoring and analytics according to the Monitoring Configuration and provides a Monitoring Result Report back to an AF in the HPLMN.

The present inventors have realized that there exist limitations in the prior art. For example, both the Minimizing Drive Test and QoE features of the Trust Surveillance function are intended by the serving (home) network to be applied to optimize the network for a specific service and to identify coverage issues in the network. The serving network may be able to configure also the inbound roamers for measurements, but then the Monitoring Result Reports are delivered to the VPLMN only. There is no currently implemented feature to allow a HPLMN to configure a UE roaming in a VPLMN to perform service- and performance-specific measurements in a transparent way with respect to the VPLMN. As will be explained in more detail below, in an embodiment the Trust Surveillance NF indicates to the UDM that, for new registration requests from UEs in a particular VPLMN, a configuration provisioning is required. The Trust Surveillance NF may indicate to the UDM what the UE should monitor, for how long, and when and where to submit the Monitoring Result Reports or UE analytics. Whenever a UE registers in the VPLMN, the UDM provisions a Monitoring Configuration to the UE via a SoR or UPU procedure. The UDM may also select UEs previously registered to the VPLMN, to which UEs the UDM may provision the Monitoring Configuration. An Authentication Server Function (AUSF) may protect the Monitoring Configuration with a block cipher.

As will be explained in more detail below, in a further embodiment the Trust Surveillance NF instructs a dedicated AF or an AAnF with the Monitoring Configuration of a particular VPLMN. The AF may take the role as a notification server for the Monitoring Configuration provisioning for UEs in a specific VPLMN. The AF may implement the server side of the enablement layer and can communicate with the enablement layer in the client in the UE. Two options are proposed:

In a first option, the AF retrieves the Serving Network Name of a UE from the AAnF when the UE registers at the AF. The Trust Surveillance NF indicates to the AF that it should notify UEs in a particular VPLMN via a secure connection with the Monitoring Configuration, and the AF identifies those UEs for which the Serving Network Name and the VPLMN identity are alike.

In a second option, the Trust Surveillance NF indicates to the AAnF that it should notify UEs in a particular VPLMN with the Monitoring Configuration. When an AF requests an AKMA key for a UE from the AAnF, the AAnF detects whether that UE's Serving Network is the VPLMN and provides the Monitoring Configuration to the AF, which provides said Monitoring Configuration via a secure connection to the UE.

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatuses may be implemented as a hardware circuit comprising custom very-large-scale integration (“VLSI”) circuits or gate arrays, off-the-shelf semiconductors such as logic chips, transistors, or other discrete components. The disclosed methods and apparatuses may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatuses may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed methods and apparatuses are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

The principle of Zero Trust Security envisages that there is a continuous evaluation of the security and the trust of the individual NFs in a network. A Trust Surveillance function is responsible for verifying the current trust status in a network and to detect when a NF is exceeding a certain threshold based on behaviour categorized as undesired or malicious. This Trust Surveillance can be extended to a whole network, e.g. a roaming partner of a given home network, e.g. a HPLMN. Thus far, there are no procedures for instructing the UE to perform certain measurements and analytics in a visited network, for instructing the UE as to how to collect those reports, and for instructing the UE as to how to send them securely to the home network. It is desired that the visited network, which is subject to monitoring for potential service level agreement violations, does not detect that the UE is configured for those measurements.

A problem with these features is that they are intended by the serving (home) network to be applied in order to optimize the network for a specific service and to identify coverage issues in the network. The serving network may also be able to configure the inbound roamers for measurements, but then the reports are delivered to the VPLMN only. There is no feature that a HPLMN is able to configure a UE roaming in a VPLMN to perform service- and performance-specific measurements in a transparent way for the VPLMN.

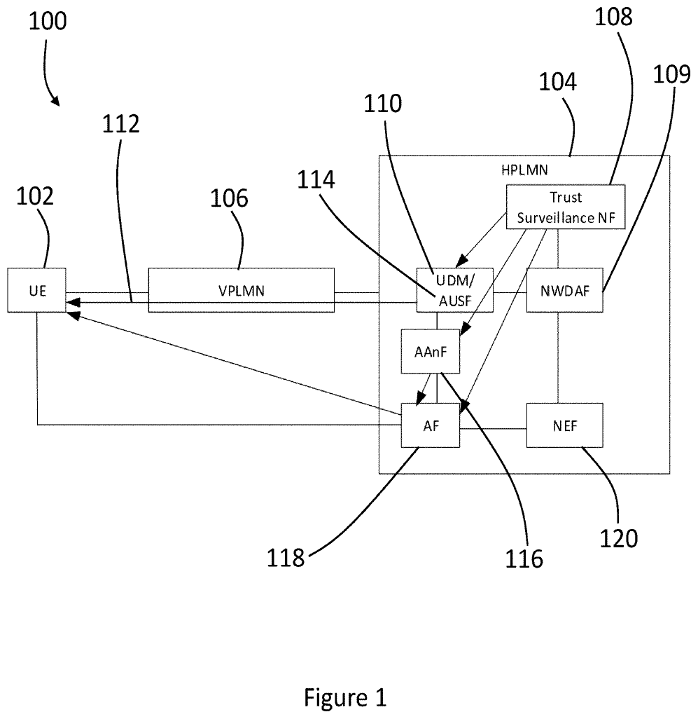

In the present disclosure, two solutions are proposed which tend to solve the above-described problems when the Trust Surveillance NF recognizes, based on analytics from the NWDAF, that a specific VPLMN has anomalies compared to, or incompatibilities with, the Service Level Agreements (SLA) (see FIG. 1).

FIG. 1 is a schematic illustration of a roaming architecture 100.

The roaming architecture 100 comprises a UE 102, a HPLMN 104 and a VPLMN 106.

The HPLMN 104 comprises the Trust Surveillance NF 108, the NWDAF 109, the UDM 110, the AUSF 114, the AAnF 116, the AF 118, and a Network Exposure Function (NEF) 120.

In an embodiment, the Trust Surveillance NF 108 of the HPLMN 104 indicates to the UDM 110 of the HPLMN 104 that for new registration requests from the UE 102 in that particular VPLMN 106 a configuration provisioning is required. The Trust Surveillance NF 108 may indicate to the UDM 110 what the UE 102 should monitor, for how long and when and where to submit the Monitoring Result Reports or UE analytics. Whenever the UE 102 registers to the VPLMN 106, the UDM 110 provisions a Monitoring Configuration to the UE 102 via a SoR or UPU procedure. Provisioning of a Monitoring Configuration to the UE 102 is illustrated in FIG. 1 with a single-headed arrow and the reference numeral 112. The UDM 110 may also select one or more UEs that previously registered to the VPLMN 106 to which to provision the Monitoring Configuration. In this embodiment, the AUSF 114 of the HPLMN 104 may protect the Monitoring Configuration with a block cipher.

In another embodiment, the Trust Surveillance NF 108 instructs a dedicated AF 118 or an AAnF 118 with the Monitoring Configuration of the VPLMN 106. The AF 118 may take the role as a notification server for the Monitoring Configuration provisioning for UEs in a specific VPLMN, e.g. the UE 102 in the VPLMN 106. The AF 118 may implement the server side of the enablement layer and can communicate with the enablement layer in the client in the UE 102.

In this embodiment, the AF 118 may retrieve the Serving Network Name of the UE 102 from the AAnF 116 when the UE 102 registers at the AF 118. The Trust Surveillance NF 108 may indicate to the AF 118 that it should notify UEs in a particular VPLMN, e.g. the UE 102 in the VPLMN 106, with the Monitoring Configuration, and the AF 118 may identify those UEs for which the Serving Network Name and the VPLMN identity are alike.

In this embodiment, the Trust Surveillance NF 108 indicates to the AAnF 116 to notify UEs in a particular VPLMN, e.g. the UE 102 in the VPLMN 106, with the Monitoring Configuration. When the AF 118 requests an AKMA key for the UE 102 from the AAnF 116, the AAnF 116 detects whether that Serving Network of the UE 102 is the VPLMN 106, and provides the Monitoring Configuration to the AF 118, which in turn provides the Monitoring Configuration to the UE 102.

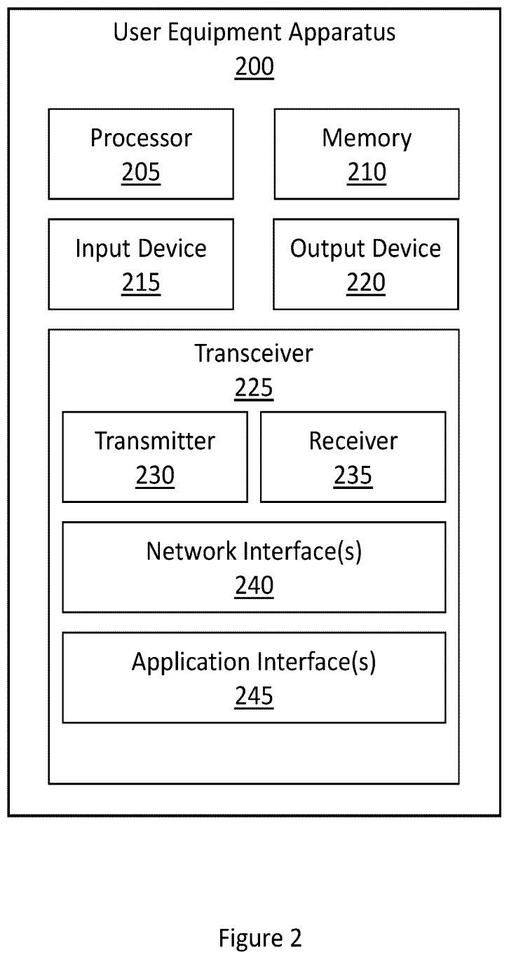

FIG. 2 depicts a user equipment apparatus (UE) 200 that may be used for implementing the methods described herein. The UE 200 is used to implement one or more of the solutions described below. The user equipment apparatus 200 includes a processor 205, a memory 210, an input device 215, an output device 220, and a transceiver 225.

The UE 200 is in accordance with the UE 102 in the roaming architecture 100.

The input device 215 and the output device 220 may be combined into a single device, such as a touchscreen. In some implementations, the UE 200 does not include any input device 215 and/or output device 220. The UE 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the UE 200 to implement the UE behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implementing a traffic category field. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the UE 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink (UL) communication signals to a base unit of a wireless communications network. Similarly, the one or more receivers 235 may be used to receive downlink (DL) communication signals from the base unit. Although only one transmitter 230 and one receiver 235 are illustrated, the UE 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

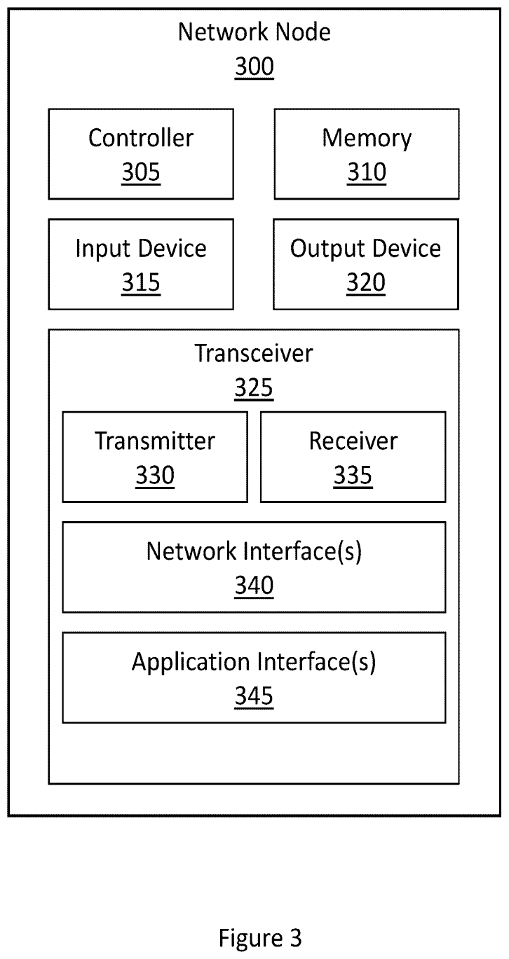

FIG. 3 depicts a network node 300 that may be used for implementing the methods described herein. The network node 300 may be one implementation of an entity in a wireless communications network, e.g. in the VPLMN 106 and/or in the HPLMN 104. The network node 300 may be, for example, the UE 200 described above. The network node 300 includes a controller 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the controller 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The controller 305 may include any known controller capable of executing computer-readable instructions and/or capable of performing logical operations. For example, the controller 305 may be a microcontroller, a microprocessor, a CPU, a GPU, an auxiliary processing unit, a FPGA, or similar programmable controller. The controller 305 may execute instructions stored in the memory 310 to perform the methods and routines described herein. The controller 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described below. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

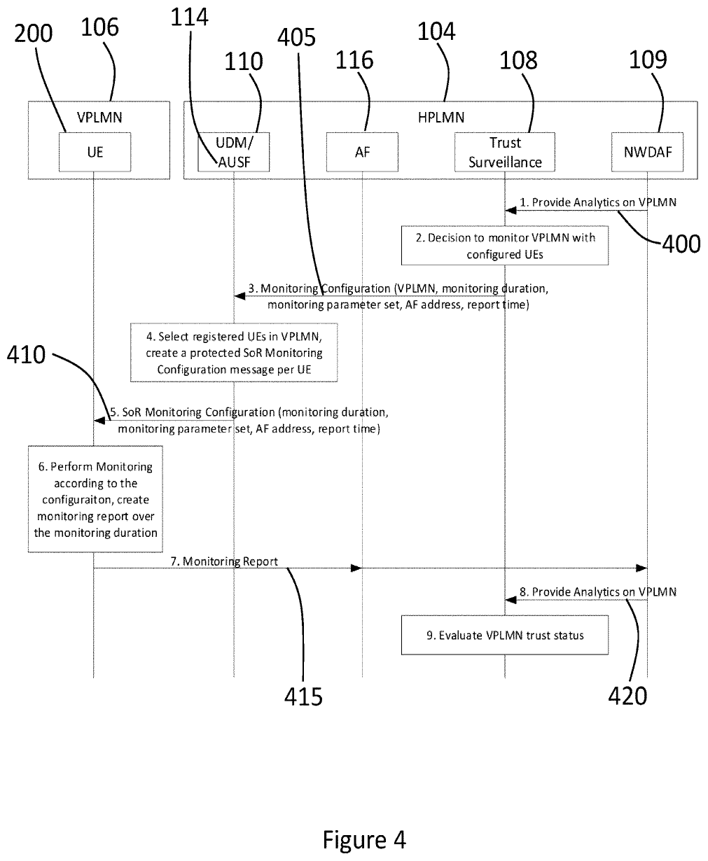

FIG. 4 is a schematic illustration depicting a procedure for configuration of the UE 200 via the UDM 110 in the HPLMN 104.

In this embodiment, the NWDAF 109 provides analytics to the Trust Surveillance NF 108. Provision of analytics to the Trust Surveillance NF 108 is indicated in FIG. 4 by a single-headed arrow and the reference numeral 400.

The Trust Surveillance NF 108 may decide, based on the analytics, that more Monitoring Result Reports from the VPLMN 106 are required. The decision may be based on, e.g., QoS analytics for home-routed traffic from the VPLMN 106, measured in the HPLMN 104. The Trust Surveillance NF 108 selects the parameter set which the UE 200 in the VPLMN 106 has to monitor. The parameter set may consist of various parameters to be monitored, e.g. a success and failure of messages on different protocol levels, QoE information, QoS, Network Slice-related information, location information, a Backoff Timer, Application Client information, etc. Furthermore, the parameter set may contain specific test cases which the UE 200 should perform, and/or may point to or index preconfigured test cases in the UE 200. The Trust Surveillance NF 108 further choses the monitoring duration and may chose a time(s) and condition(s) (e.g. only via Wi-Fi or only from the HPLMN etc.) to report the Monitoring Result Report as well the AF address for the reporting.

In this embodiment, the Trust Surveillance NF 108 sends a Monitoring Request to the UDM 110, including Monitoring Configuration e.g. the identity of the VPLMN 106, the parameter set to be monitored, a monitoring duration, a time at, for, or during which to report the monitoring results report, and an address of the AF 118 to retrieve the reports. The sending of the Monitoring Request to the UDM 110 is indicated in FIG. 4 by a single-headed arrow and the reference numeral 405.

In this embodiment, the UDM 110 stores the Monitoring Request and may apply it to UEs already registered in the VPLMN 106, e.g. the UE 200, or only to UEs that register from this point in time until the monitoring duration is expired.

In this embodiment, the UDM 110 creates an UPU/SoR Monitoring Configuration payload with the information retrieved from the Trust Surveillance NF 108, i.e. the identity of the VPLMN 106, the parameter set to be monitored, a monitoring duration, a time at, for, or during which to report the monitoring results report, and an address of the AF 118 to retrieve the reports. For each UE, the UDM 110 wants to send a UPU/SoR message with the Monitoring Configuration payload, in which case the UDM 110 may contact the AUSF 114 for the protection of the payload. In some embodiments, the payload is only integrity protected, e.g., similar to a conventional UPU/SoR message. The AUSF 114 may use the block cipher in a similar way as for the encryption of Radio Resource Control (RRC) signaling and User Plane (UP) traffic. In general one of the following four options may be implemented: 1. No protection of the payload is implemented; 2. Only integrity protection of the payload is used, e.g. as may be used for conventional UPU/SoR messages; 3. Encryption of the payload may be implemented; or 4. Both integrity protection and encryption of the payload may be implemented.

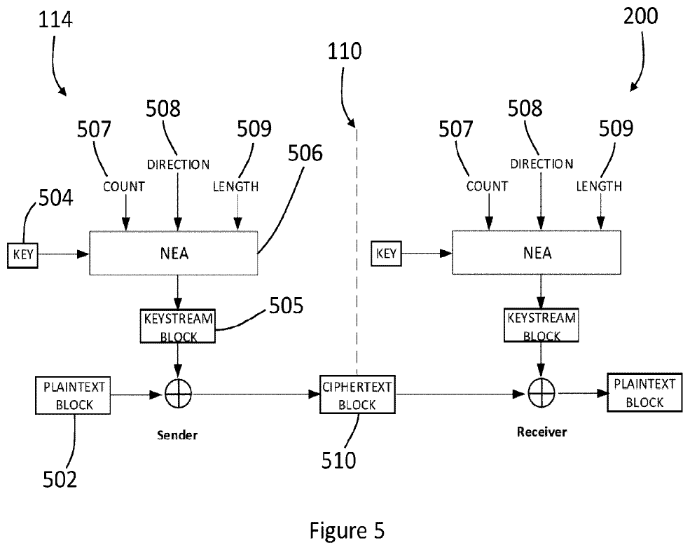

FIG. 5 is a schematic illustration depicting a procedure for Monitoring Configuration payload protection with the block cipher, which creates a key stream block using an encryption key and other parameters. The key stream block is used to encrypt a plaintext block of the same size into a ciphertext block of the same size.

The AUSF 114 uses the Monitoring Configuration payload as a plaintext block 502. An input cipher key 504 may be a Key AUSF (K_{AUSF}) or a derived key from the K_{AUSF} for the payload encryption, and is used to generate a keystream block 505. The keystream block 505 may be generated using a New Radio Encryption Algorithm (NEA) 506. The NEA 506 may include or require a count 507, a direction 508 which may be, e.g., 1 for downlink and 0 for uplink, and a length 509 of the keystream. From the plaintext block 502 and the keystream block 505, a ciphertext block 510 is then generated and returned to the UDM 110 together with a NEA identifier and the Media Access Control (MAC)-I for integrity, as computed for SoR/UPU. The UDM 110 then includes the protected, i.e. encrypted, Monitoring Configuration payload in the UPU/SoR message to each affected UE respectively, e.g. the UE 200.

Referring again to FIG. 4, the UDM 110 sends a UPU/SoR message to the identified UEs, e.g. the UE 200, including the protected Monitoring Configuration including the payload parameter set to be monitored, monitoring duration, time to report the monitoring results report and the address of the AF to retrieve the reports, e.g. the AF 118. Furthermore, the sending of the UPU/SoR message to the identified UEs NEA identifier 512 and the MAC-I for integrity are included in the message. The sending of the Monitoring Request by the UDM 110 to the UE 200 is indicated in FIG. 4 by a single-headed arrow and the reference numeral 410.

In this embodiment, when the UE 200 receives the UPU/SoR message, it verifies the MAC-I and deciphers it receiver-side, as depicted in, and described above with reference to, FIG. 5. In particular. the UE 200 uses the same parameters for the block cipher as the AUSF 114, e.g. the same key. The UE 200 then performs the monitoring and runs the test cases, if defined, for the monitoring duration. The UE 200 may already generate analytics from the monitoring results.

In this embodiment, once the monitoring duration is over and/or the reporting time approached, then the UE 200 sends the Monitoring Result Report to the AF 118 address provisioned in the Monitoring Configuration payload. The AF 118 forwards the Monitoring Result Report to the corresponding NWDAF 109. The forwarding of the Monitoring Result Report by the UE 200 to the NWDAF 109 is indicated in FIG. 4 by a single-headed arrow and the reference numeral 415.

In this embodiment, the NWDAF 109 creates analytics out of the Monitoring Result Report. These analytics may be based on reports from more than one UE.

In this embodiment, the NWDAF 109 provides the analytics to the Trust Surveillance NF 108 for further categorization of the VPLMN 106 and to trigger further actions. The provision of the analytics to the Trust Surveillance NF 108 by the NWDAF 109 is indicated in FIG. 4 by a single-headed arrow and the reference numeral 420.

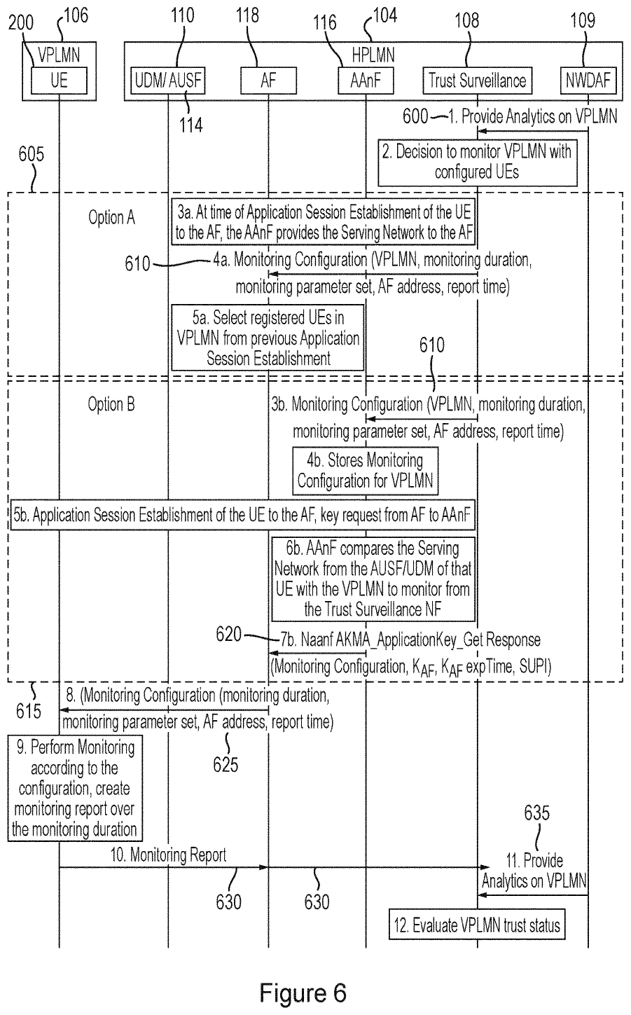

FIG. 6 is a schematic illustration depicting a procedure for provisioning the Monitoring Configuration to the UE 200 via the AF 118, returning the Monitoring Results Report to the NWDAF 109 for analysis, and relaying the resulting analytics to the Trust Surveillance NF 108.

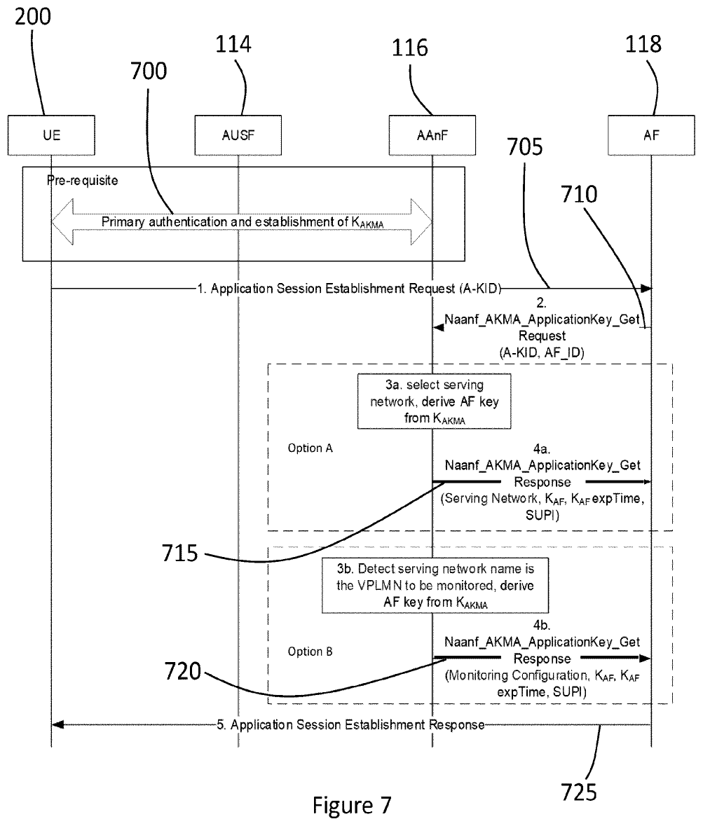

As a precondition to the procedure of FIG. 6, the AAnF 116 retrieves the serving network name at the time of the primary authentication of each UE. Described herein are two ways of doing so, as depicted in FIG. 7, which is a schematic illustration depicting Application Session Establishment via AF provisioning.

In a first implementation, the AAnF 116 provides the serving network name to the AF 118, and the AF 118 selects which UEs are subject to the Monitoring Request from the Trust Surveillance NF 108. The AF 118 may store the serving network name with UE Identities, and may also subsequently identify UEs in the VPLMN of interest, not only at the time of the Application Session Establishment procedure.

In a second implementation, the AAnF 116 receives the Monitoring Request from the Trust Surveillance NF 108 and selects the affected UEs, while, e.g. at the same time that, the AF 118 requests the AKMA key. The AAnF 116 then provides the Monitoring Configuration to the AF 118, and the AF 118 in turn provides the Monitoring Configuration to the UE 200. This procedure is performed at the time at which the UE 200 performs the Application Session Establishment procedure with the AF 118.

The steps of the process of FIG. 7 are according to the AKMA procedure in 3GPP TS 33.535 “Authentication and Key Management for Applications (AKMA) based on 3GPP credentials in the 5G System (5GS)”, 17.4.0, (2021-12), clause 6.2 “Deriving AKMA Application Key for a specific AF”. The following differences are described with reference to FIG. 6.

In this embodiment, before communication between the UE 200 and the AKMA AF 118 can start, the UE 200 and the AKMA AF 118 needs to know whether to use AKMA. This knowledge may be implicit to the specific application on the UE 200 and/or the AKMA AF 118, or may be indicated by the AKMA AF 118 to the UE 200. Further, during primary authentication, when the key is provisioned to the AAnF 116, the current Serving Network Name of the UE 200 is also provisioned.

The UE 200 generates the AKMA Anchor Key (K_{AKMA}) and an Application Session Establishment Request (A-KID) from the K_{AUSF} before initiating communication with the AKMA AF 118. When the UE 200 initiates communication with the AKMA AF 118, it includes the derived A-KID in the A-KID message. The UE 200 may derive an Application Function Key (K_{AF}) either before or after sending the message. Establishment of the K_{AKMA} and pre-requisite authentication of the AAnF 116 is indicated in FIG. 7 with a double-headed arrow and the reference numeral 700. The generation and sending of the A-KID to the AKMA AF 118 is indicated in FIG. 7 with a single-headed arrow and the reference numeral 705.

In this embodiment, if the AF 118 does not have an active context associated with the received A-KID, then the AF 118 selects the AAnF 116 and sends a “Naanf AKMA ApplicationKey Get” request to the AAnF 116 with the A-KID, thereby requesting the KAF for the UE 200. The AF 118 also includes its identity (AF ID) in the “Naanf AKMA ApplicationKey Get” request. The sending of the “Naanf AKMA ApplicationKey Get” request to the selected AAnF 116 by the AF 118 is indicated in FIG. 7 with a single-headed arrow and the reference numeral 710.

In this embodiment, the AF ID consists of the Fully Qualified Domain Name (FQDN) of the AF 118 and the Ua* security protocol identifier. The latter parameter, the Ua* security protocol identifier, identifies the security protocol that the AF 118 will use with the UE 200.

In this embodiment, the AAnF 116 checks whether it can provide the service to the AF 118 based on the configured local policy or based on authorization information or policy provided by a Network Repository Function (NRF) using the AF ID. If the AAnF 116 succeeds, the following procedures are executed. Otherwise, the AAnF 116 rejects, i.e. does not execute, the following procedures.

In this embodiment, the AAnF 116 verifies whether the subscriber is authorized to use AKMA based on the presence of the UE-specific K_{AKMA} key identified by the A-KID.

If the K_{AKMA} is present in the AAnF 116, the AAnF 116 continues with the key-derivation steps outlined below.

If, on the other hand, the K_{AKMA} is not present in the AAnF 116, the AAnF 116 continues with the error response steps outlined below.

In a first case, the AAnF 116 derives the AKMA Application Key (K_{AF}) from the K_{AKMA} if it does not already have the K_{AF}. The AAnF 116 then selects the Serving Network Name of the UE 200 retrieved from the AUSF 114, together with the K_{AKMA} following primary authentication 700.

Then, the AAnF 116 sends a “Naanf AKMA ApplicationKey Get” response to the AF 118, including a Subscription Permanent Identifier (SUPI), the K_{AF}, a K_{AF} expiration time, and the Serving Network Name. The sending of the “Naanf AKMA ApplicationKey Get” response (including the Serving Network Name) to the AF 118 by the AAnF 116 is indicated in FIG. 7 with a single-headed arrow and the reference numeral 715.

In a second case, the AAnF 116 derives the K_{AF} from the K_{AKMA} if it does not already have the K_{AF}. The AAnF 116 then selects the Serving Network Name of the UE 200 retrieved from the AUSF 114, together with the K_{AKMA} following primary authentication 700.

As a precondition, the Trust Surveillance NF 108 provisions the Monitoring Configuration, including the VPLMN identity, to the AAnF 116 be monitored. The AAnF 116 compares the Serving Network Name with the VPLMN Identity and, if they match or are sufficiently alike, the AAnF 116 includes the Monitoring Configuration in the message back to the AF 118 in the following step.

Then, the AAnF 116 sends said message, namely the “Naanf AKMA ApplicationKey Get” response, to the AF 118 with the SUPI, the K_{AF}, the K_{AF} expiration time, and the Monitoring Configuration for the UE 200. The sending of the “Naanf AKMA ApplicationKey Get” response (including the Monitoring Configuration) to the AF 118 by the AAnF 116 is indicated in FIG. 7 with a single-headed arrow and the reference numeral 720.

In both the first and the second case, the AF 118 next sends the Application Session Establishment Response to the UE 200. The sending of the Application Session Establishment response to the UE 200 by the AF 118 is indicated in FIG. 7 with a single-headed arrow and the reference numeral 525. If the information at 715/720 indicates failure of the AKMA key request, i.e. if the presence of the K_{AKMA} is not identified by the A-KID, the AF 118 rejects the Application Session Establishment by including a failure cause. In this case, one or more error response messages may instead be provisioned at 525. Subsequently, the UE 200 may trigger a new Application Session Establishment request by providing the latest A-KID to the AKMA AF 118, in accordance with the Application Session Establishment Request 705 described above. In the case where an Application Session Establishment Response is set up, in accordance with 525 described above, the UE 200 and the AF 118 set up a secure connection based on the AF key, i.e. the K_{AF}.

Referring again to FIG. 6 and the procedure which it depicts, the NWDAF 109 provides analytics to the Trust Surveillance NF 108, as indicated by a single-headed arrow and the reference numeral 600.

In this embodiment, the Trust Surveillance NF 108 decides, based on the analytics, that more Monitoring Results Reports from the VPLMN 106 are required. This decision may be based on, e.g., QoS analytics for home-routed traffic from this VPLMN 106 measured in the HPLMN 104. The Trust Surveillance NF 108 selects the parameter set which the UE 200 in the VPLMN 106 has to monitor. The parameter set may consist of various parameters to be monitored, e.g. the success or failure of messages on different protocol levels, QoE information, QoS, Network Slice-related information, location information, a Backoff Timer, Application Client information, etc. Furthermore, the parameter set may contain specific test cases which the UE 200 should perform, and/or may point to or index preconfigured test cases in the UE 200. The Trust Surveillance NF 108 further choses the monitoring duration and may chose time(s) and conditions (e.g. only via WLAN or only from the HPLMN etc.) to report the Monitoring Result Report as well the AF address for the reporting.

In a first case, indicated in FIG. 6 by a dotted box and the reference numeral 605, the AAnF 116 first provides the Serving Network Name, retrieved from the AUSF 114, to the AF 118 together with the SUPI, the K_{AF} and the K_{AF} expiration time, at the time at which the UE 200 performs the Application Session Establishment procedure 715 as described above with reference to FIG. 7. The first case 605 may be considered a first option for executing or continuing the procedure of FIG. 6.

In the first case 605, the Trust Surveillance NF 108 sends a Monitoring Request to the AF 118. The Monitoring Request may include the Monitoring Configuration e.g. the VPLMN identity, the parameter set to be monitored, the monitoring duration, the time(s) at, by or during which to report the Monitoring Results Report(s), and the address of the AF 118 to retrieve the report(s). The sending of the Monitoring Request by the Trust Surveillance NF 108 to the AF 118 is indicated in FIG. 6 by a single-headed arrow and the reference numeral 610.

In the first case 605, the AF 118 selects the registered UEs, e.g. the UE 200, with a Serving Network Name which matches or is alike the VPLMN identity from previous and upcoming Application Session Establishments. The AF 118 generates a Monitoring Configuration request message for all identified UEs.

The procedure then continues, in the first case 605, with the AF 118 provisioning the UE 200 with the Monitoring Configuration, as is explained in more detail below.

In a second case, indicated in FIG. 6 by a dotted box and the reference numeral 615, the Trust Surveillance NF 108 sends a Monitoring Request to the AAnF 116, the Monitoring Request including Monitoring Configuration e.g. the VPLMN identity, the parameter set to be monitored, the monitoring duration, the time(s) at, by, or during which to report the Monitoring Results Report(s) and the address of the AF 118 to retrieve the report(s). The sending of the Monitoring Request by the Trust Surveillance NF 108 to the AAnF 116 is indicated in FIG. 6 by a single-headed arrow and the reference numeral 620. The second case 615 may be considered a second option for executing or continuing the procedure of FIG. 6.

In the second case 615, the AAnF 116 stores the Monitoring Configuration for a future key request from an AF, e.g. the AF 118.

In the second case 615, the UE 200 performs the Application Session Establishment with the AF 118, and the AF 118 sends an AKMA key request according to 710 indicated in, and described above with reference to, FIG. 7.

In the second case 615, the AAnF 116 compares whether the Serving Network Name for the UE 200, retrieved from the AUSF 114 following primary authentication 700, matches or is alike the VPLMN identity retrieved from the Trust Surveillance NF 108. The AAnF 116 then generates a Monitoring Configuration request message.

In the second case 615, the AAnF 116 provides the Monitoring Configuration to the AF 118 together with the with SUPI, the KAF and the KAF expiration time. The provisioning of the “Naanf AKMA ApplicationKey Get” response (including the Monitoring Configuration) to the AF 118 by the AAnF 116 is indicated in FIG. 6 with a single-headed arrow and the reference numeral 620, and is in accordance with the sending 720 of the response, indicated in, and described above with reference to, FIG. 7.

The procedure then continues, in the second case 615, with the AF 118 provisioning the UE 200 with the Monitoring Configuration, as is explained in more detail below.

Following either the first case 605 or the second case 615, after the UE 200 and the AF 118 set up a secure connection based on the K_{AF}, the AF sends a Monitoring Configuration message to the UE 200, including the payload parameter set to be monitored, the monitoring duration, the time at, by, or during which to report the Monitoring Results Report(s) and the address of the AF 118 to retrieve the report(s). The sending the Monitoring Configuration message to the UE 200 by the AF 118 is indicated in FIG. 6 by a single-headed arrow and the reference numeral 625.

When the UE 200 receives the Monitoring Configuration message, it performs the monitoring for which it has been configured, and runs the test cases, if defined, for the configured monitoring duration. The UE 200 may already generate analytics from the monitoring results.

Once the monitoring duration is over, i.e. has passed or elapsed, and/or the reporting time has passed or elapsed, the UE 200 sends the Monitoring Results Report(s) to the AF address provisioned in the Monitoring Configuration payload. The AF 118 forwards the Monitoring Result Report(s) to the corresponding NWDAF 109. The sending of the Monitoring Results Report(s) to the AF 118 by the UE 200, and the forwarding of the Monitoring Results Report(s) by the AF 118 to the NWDAF 109, is indicated in FIG. 6 by a single-headed arrow and the reference numeral 630.

The NWDAF 109 creates analytics from or based on the received Monitoring Result Report(s). These analytics may be based on the report(s) from many UEs, i.e. following the NWDAF 109 receiving respective Monitoring Results Reports from UEs other than or in addition to the UE 200.

In this embodiment, the NWDAF 109 provides the analytics to the Trust Surveillance NF 108 for further categorization of the VPLMN 106, and to trigger further actions. The provisioning of the analytics to the Trust Surveillance NF 108 by the NWDAF 109 is indicated in FIG. 6 by a single-headed arrow and the reference numeral 635.

In an embodiment, there is provided a first apparatus, e.g. an apparatus in accordance with the UDM 110, or in accordance with the AF 118, and in accordance with the UE 200, the apparatus comprising a transceiver, e.g. the transceiver 225, and a processor, e.g. the processor 205, coupled to the transceiver. In this embodiment, the processor and the transceiver are configured to cause the apparatus to receive a Monitoring Configuration Request from the Trust Surveillance NF 108, which Trust Surveillance NF 108 belongs to another apparatus other than the first apparatus.

In this embodiment, the Monitoring Configuration Request comprises an identifier for the VPLMN 106, information specifying a parameter set to be monitored, and an address of the AF 118.

In this embodiment, the processor and the transceiver are further configured to cause the apparatus to select a UE, in accordance with the 200, other than the first apparatus, the UE being registered in the VLPMN 106 identified by the identifier.

In this embodiment, the processor and the transceiver are further configured to cause the apparatus to send, to the selected UE apparatus, a Monitoring Configuration Message, the Monitoring Configuration Message comprising the information specifying a parameter set to be monitored and the address of the AF 118.

In this embodiment, the Monitoring Configuration Message may comprise a payload sent in a UPU/SoR message.

In this embodiment, such a payload may be integrity protected, e.g. as a normal or typical UPU/SoR message.

In this embodiment, the processor and the transceiver may be further configured to cause the apparatus to send, for the selected UE apparatus, a protection request message to the AUSF 114, which AUSF 114 belongs to another apparatus other than the first apparatus.

In this embodiment, the processor and the transceiver may be further configured to cause the apparatus to receive, from the AUSF 114, the Monitoring Configuration Message for sending to the selected UE. In this embodiment, the Monitoring Configuration Message may be an encrypted message.

In this embodiment, the Monitoring Configuration Message may comprise one or more of: a ciphertext message, e.g. the ciphertext block 510; an encryption algorithm identifier, e.g. the NEA 506; or a MAC-I field.

In this embodiment, the Monitoring Configuration Request and the Monitoring Configuration Message may comprise one or more of: a monitoring duration for the UE; or one or more times for the UE to report a Monitoring Results Report, e.g. a report in accordance with the Monitoring Results Report described above with reference to FIG. 6.

In this embodiment, the processor and the transceiver may be configured to cause the apparatus to either: select the UE, the UE being currently registered in the VPLMN 106; or select only a UE that registers in the VPLMN 106 subsequent to the apparatus receiving the Monitoring Configuration Request.

In this embodiment, the apparatus may be a UDM, e.g. in accordance with the UDM 110.

In this embodiment, the apparatus may be an AF, e.g. in accordance with the AF 118.

In an embodiment, there is provided a UE, e.g. in accordance with the UE 200, the UE comprising a transceiver, e.g. the transceiver 225, and a processor, e.g. the processor 205, coupled to the transceiver. In this embodiment, the processor and the transceiver are configured to cause the apparatus to receive a Monitoring Configuration Message, e.g. from a UDM of, or on, another apparatus.

In this embodiment, the Monitoring Configuration Message comprises: information specifying a parameter set to be monitored; and an address of an AF, e.g. of, or on, another apparatus, the AF being in accordance with the AF 118.

In this embodiment, the processor and the transceiver are configured to cause the UE to perform monitoring of the specified parameter set of the VPLMN 106, with which the UE is registered.

In this embodiment, the processor and the transceiver are configured to cause the UE to send a Monitoring Results Report comprising a result of said monitoring to the address of the AF.

In this embodiment, the Monitoring Configuration Message may be a protected Monitoring Configuration Message comprising one or more of: a ciphertext message, e.g. the ciphertext block 510; an encryption algorithm identifier, e.g. the NEA 506; or a MAC-I field.

In this embodiment, the processor and the transceiver may be further configured to cause the UE to: select a protection key, e.g. the input cipher key 504, for the Monitoring Configuration Message; compute a keystream block, e.g. the keystream block 505, with the selected protection key and an encryption algorithm identified by the encryption algorithm identifier; and compute a (e.g., plaintext) Monitoring Configuration Message using the protected Monitoring Configuration Message and the keystream block.

In this embodiment, a counter, a length of keystream block, and/or a direction identifier may be input parameters for computing the keystream block.

In this embodiment, the processor and the transceiver may be further configured to cause the UE to: compute a MAC-I field over the (e.g., plaintext) Monitoring Configuration Message with the protection key; and verify whether the computed MAC-I field matches a MAC-I filed in the received Monitoring Configuration Message.

In an embodiment, there is provided an apparatus, e.g. an apparatus in accordance with the AUSF 114, the apparatus comprising a transceiver, e.g. the transceiver 225, and a processor, e.g. the processor 205, coupled to the transceiver. In this embodiment, the processor and the transceiver are configured to cause the apparatus to receive a protection request message, e.g. for SoR/UPU from a UDM of, or on, another apparatus.

In this embodiment, the Monitoring Configuration Message comprises: information specifying a parameter set to be monitored; and an address of an AF, e.g. of, or on, another apparatus, the AF being in accordance with the AF 118.

In this embodiment, the Monitoring Configuration Message comprises: information specifying a parameter set to be monitored; and an address of an AF, e.g. of, or on, another apparatus, the AF being in accordance with the AF 118.

In this embodiment, the processor and the transceiver are configured to cause the apparatus to select a protection key, e.g. the input cipher key 504, for the Monitoring Configuration Message using the identifier for the UE, e.g. a SUPI.

In this embodiment, the processor and the transceiver are configured to cause the apparatus to compute a keystream block, e.g. the keystream block 505, with the protection key and an encryption algorithm; and compute a (e.g., plaintext) ciphertext block, e.g. the ciphertext block 510, using the Monitoring Configuration Message and the keystream block, thereby to provide a protected Monitoring Configuration Message.

In this embodiment, the processor and the transceiver are configured to send, in response to the protection request message, a response message, e.g. to the UDM on another apparatus, comprising the protected Monitoring Configuration Message and an encryption algorithm identifier, e.g. the NEA 506, that identifies the encryption algorithm.

In this embodiment, a counter, a length of keystream block, and/or a direction identifier may be input parameters for computing the keystream block.

In this embodiment, the processor and the transceiver may be further configured to cause the apparatus to compute a MAC-I field over the Monitoring Configuration Message with the protection key, and the response message may further comprise the MAC-I field.

In this embodiment, the apparatus may be an AUSF, e.g. in accordance with the AUSF 114.

In an embodiment, there is provided an apparatus, e.g. an apparatus in accordance with the AAnF 114, the apparatus comprising a transceiver, e.g. the transceiver 225, and a processor, e.g. the processor 205, coupled to the transceiver. In this embodiment, the processor and the transceiver are configured to cause the apparatus to receive a Monitoring Configuration Request from a Trust Surveillance NF, e.g. in accordance with the Trust Surveillance NF 108 on another apparatus.

In this embodiment, the Monitoring Configuration Message comprises: information specifying a parameter set to be monitored; and an address of an AF, e.g. of, or on, another apparatus, the AF being in accordance with the AF 118.

In this embodiment, the Monitoring Configuration Request comprises: an identifier for a VPLMN, e.g. in accordance with the VPLMN 106; information specifying a parameter set to be monitored; and an address of an AF, e.g. of, or on, another apparatus, the AF being in accordance with the AF 118.

In this embodiment, the processor and the transceiver are configured to cause the apparatus to receive a key request from an AF, e.g. of, or on, another apparatus.

In this embodiment, the processor and the transceiver are configured to acquire a Serving Network Name of the UE is alike, e.g. matches, the VPLMN identified by the identifier.

In this embodiment, the processor and the transceiver are configured to cause the apparatus to, responsive to detecting that the Serving Network Name of the UE is alike the VPLMN identified by the identifier, and in response to the key request, send a key response message to the AF, the key response message comprising the Monitoring Configuration Request.

In this embodiment, the apparatus may be an AKMA AAnF, e.g. in accordance with the embodiment described above with reference to FIG. 6.

An issue with Minimizing Drive Test and OoE reporting features is that those are intended to be applied to optimize the network only for a specific service, and to identify coverage issues in the network. The serving network may be able to configure the inbound roamers for measurements, but then the reports are delivered to the VPLMN only. There is no existing feature whereby a HPLMN is able to configure UE roaming in a VPLMN to perform service- and performance-specific measurements a way which is transparent to the VPLMN, thereby to allow a later trust evaluation of that VPLMN.

Advantageously, the embodiments described herein tend to allow trust surveillance to be extended to a visited network.

Advantageously, the embodiments described herein tend to allow instruction of a UE to perform certain measurements and analytics in a visited network, to collect reports on the analytics, and to send said reports securely to the home network, i.e. an HPLMN.

More advantageously still, the embodiments described herein tend to ensure that the visited network, subject to monitoring for potential SLA violations, does not detect that the UE is configured for the analytics described herein. Further misbehaving VPLMNs can be effectively detected and actions can be taken from the HPLMN side accordingly in order to compensate for the negative effects caused by the misbehaving VPLMN.

It should be noted that the above-mentioned methods and apparatuses illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed methods and apparatuses may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatuses may be practiced in other specific forms. The described methods and apparatuses are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for wireless communication, comprising:
at least one memory; and
at least one processor coupled with the at least one memory and configured to cause the apparatus to:
receive a monitoring configuration request from a trust surveillance network function, the monitoring configuration request comprising an identifier for a visited public land mobile network (VPLMN), information specifying a parameter set to be monitored, and an address of an application function (AF);
select a user equipment (UE) registered in the VPLMN identified by the identifier; and
send, to the selected UE, a monitoring configuration message, the monitoring configuration message comprising the information specifying the parameter set to be monitored, and the address of the AF.

2. The apparatus of claim 1, wherein the monitoring configuration message comprises a payload sent as one of a UE parameter update (UPU) or a steering of roaming (SoR) message.

3. The apparatus of claim 2, wherein the payload is integrity protected.

4. The apparatus of claim 1, wherein the at least one processor is configured to cause the apparatus to:
send, for the selected UE, a protection request message to an authentication server function (AUSF), the protection request message comprising the information specifying the parameter set to be monitored and the address of the AF; and
receive, from the AUSF, the monitoring configuration message for sending to the selected UE, wherein the monitoring configuration message is an encrypted message.

5. The apparatus of claim 4, wherein the protection request message further comprises an identifier of the UE.

6. The apparatus of claim 4, wherein the monitoring configuration message comprises one or more of:
a ciphertext message;
an encryption algorithm identifier; or
a message authentication code for integrity (MAC-I) field.

7. The apparatus of claim 1, wherein the monitoring configuration request and the monitoring configuration message further comprises one or more of:
a monitoring duration for the UE; or
one or more times for the UE to report a monitoring results report.

8. The apparatus of claim 1, wherein the at least one processor is configured to cause the apparatus to one of:
select the UE that is currently registered in the VPLMN; or
select only the UE that registers in the VPLMN subsequent to the apparatus receiving the monitoring configuration request.

9. The apparatus of claim 1, wherein the apparatus is a unified data management (UDM) module.

10. The apparatus of claim 1, wherein the apparatus is the AF.

11. The apparatus of claim 10, wherein the at least one processor is configured to cause the apparatus to receive one or more of a serving network name, a subscription permanent identifier (SUPI), an application function key (K_{AF}), or a KAF expiration time.

12. A user equipment (UE) for wireless communication, comprising:
at least one memory; and
at least one processor coupled with the at least one memory and configured to cause the UE to:
receive a monitoring configuration message, the monitoring configuration message comprising information specifying a parameter set to be monitored and an address of an application function (AF);
perform monitoring of the specified parameter set, wherein the specified parameter set is a parameter set of a visited public land mobile network (VPLMN) with which the UE is registered; and
send a monitoring results report comprising a result of the monitoring to the address of the AF.

13. The UE of claim 12, wherein the monitoring configuration message is a protected monitoring configuration message comprising one or more of:
a ciphertext message;
an encryption algorithm identifier; or
a message authentication code for integrity (MAC-I) field.

14. The UE of claim 13, wherein the at least one processor is configured to cause the UE to:
select a protection key for the monitoring configuration message;
compute a keystream block with the selected protection key and an encryption algorithm identified by the encryption algorithm identifier; and
compute a second monitoring configuration message using the monitoring configuration message and the keystream block.

15. The UE of claim 14, wherein the at least one processor is configured to cause the UE to:
compute the MAC-I field over the monitoring configuration message with the selected protection key; and
verify whether the computed MAC-I field matches a MAC-I field in the received monitoring configuration message.

16. An apparatus for wireless communication, comprising:
at least one memory; and
at least one processor coupled with the at least one memory and configured to cause the apparatus to:
receive a protection request message comprising a monitoring configuration message and an identifier for a user equipment (UE), wherein the monitoring configuration message comprises information specifying a parameter set to be monitored and an address of an application function (AF);
select a protection key for the monitoring configuration message using the identifier for the UE;
compute a keystream block with the protection key and an encryption algorithm;
compute a ciphertext block using the monitoring configuration message and the keystream block for a protected monitoring configuration message; and
send, in response to the protection request message, a response message comprising the protected monitoring configuration message and an encryption algorithm identifier that identifies the encryption algorithm.

17. The apparatus of claim 16, wherein the at least one processor is configured to cause the apparatus to compute a message authentication code for integrity (MAC-I) field over the monitoring configuration message with the protection key, and wherein the response message further comprises the MAC-I field.

18. The apparatus of claim 16, wherein the apparatus is an authentication server function (AUSF).

19. An apparatus for wireless communication, comprising:
at least one memory; and
at least one processor coupled with the at least one memory and configured to cause the apparatus to:
receive a monitoring configuration request from a trust surveillance network function, the monitoring configuration request comprising an identifier for a visited public land mobile network (VPLMN), information specifying a parameter set to be monitored, and an address of an application function (AF);
receive a key request from the AF;
acquire a serving network name of a user equipment (UE);
detect whether the serving network name of the UE is alike the VPLMN identified by the identifier; and
responsive to detecting that the serving network name of the UE is alike with the VPLMN identified by the identifier, in response to the key request, send a key response message to the AF, the key response message comprising the monitoring configuration request.

20. The apparatus of claim 19, wherein the apparatus is an authentication and key management for applications (AKMA) anchor function (AAnF).
